(19) United States
(12) Patent Application Publication
(10) Pub. No.: US 2015/0143807 A1
(43) Pub. Date: May 28, 2015

(54) ENGINE HAVING TURBO CHARGER

(71) Applicant: Hyundai Motor Company, Seoul (KR)

(72) Inventors: Yoon Joo Kim, Yongin-si (KR); II Joong Hwang, Yongin-si (KR); Hyun Jun Lim, Incheon (KR); Nahm Roh Joo, Yongin-si (KR); Dong Hee Han, Seoul (KR); Seung Kook Han, Seoul (KR); Jong II Park, Seoul (KR)

(73) Assignee: Hyundai Motor Company, Seoul (KR)

(21) Appl. No.: 14/304,692

(22) Filed: Jun. 13, 2014

(30) Foreign Application Priority Data
Nov. 22, 2013 (KR) 10-2013-0143269

(51) Int. Cl. F02B 47/08; F02B 37/22; F01N 3/20

(52) U.S. Cl. CPC F02B 47/08; F01N 3/20; F02B 37/22
USPC 60/602

(57) ABSTRACT

An engine having a turbocharger may include an intake route control valve disposed on a first intake line that supplies outside air to an intake manifold, a second intake line bypassing the intake route control valve, a first exhaust line in which exhaust gas from an exhaust manifold flows, a second exhaust line bypassing an exhaust route control valve disposed on the first exhaust line to join the first exhaust line, a turbocharger operated by exhaust gas in the second exhaust line to compress intake air in the second intake line, and a first catalyst unit disposed at a downstream side of the exhaust route control valve on the first exhaust line. The first catalyst unit may include a first brick disposed at an upstream side and a second brick disposed at a downstream side of the first brick with a predetermined distance, and the second exhaust line joins the first exhaust line at a portion between the first brick and the second brick.

### CROSS-REFERENCE TO RELATED APPLICATION

The present application claims priority of Korean Patent Application Number 10-2013-0143269 filed on Nov. 22, 2013, the entire contents of which application are incorporated herein for all purposes by this reference.

### BACKGROUND OF INVENTION

1. Field of Invention

The present invention is related to an engine having a turbocharger that improves an output, a combustion efficiency, and exhaust gas quality during a low speed area by using a turbocharger and recirculating exhaust gas.

2. Description of Related Art

Generally, a diesel engine has been known that its fuel consumption is low and the efficiency thereof is good, as compared to a gasoline engine. Its efficiency is about 40%, and this can be realized by a high compression ratio. Recently, a turbocharger and an intercooler are mounted on the engine so as to achieve further larger amount of output.

Like this, the engine having the turbocharger sucks outside air or exhaust gas to compress this, and the compressed air is supplied to combustion room of the engine side.

However, the air that is rapidly compressed absorbs heat that is generate during the compression process or heat of the turbocharger so that the density thereof is decreased, and resultantly charging efficiency inside an engine combustion chamber is deteriorated. Thus, an intercooler is used to cool the compressed air so that the density of compressed air is increased, and resultantly large amount of air is supplied to an engine combustion chamber so that high output can be offered.

Researches for reducing fuel consumption and simultaneously increasing output torque at a middle/lower speed area of an engine having a turbocharger has been undertaken.

Meanwhile, when exhaust gas passes a turbocharger and a catalyst unit, a flowing resistance is formed by close cells of a catalyst unit, and resultantly back pressure is formed at an exhaust manifold side. Accordingly, due to the exhaust deterioration of an exhaust gas at a low speed/low load of an engine, the output can be deteriorated and the fuel consumption can be increased.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention has been made in an effort to provide an engine having a turbocharger having advantages of increasing output torque and reducing fuel consumption at a middle/lower speed area of a rotation speed of an engine having a turbocharger and reducing back pressure of exhaust gas passing a turbocharger so that the output is increased and fuel consumption is reduced.

An engine having a turbocharger according to various aspects of the present invention may include an intake route control valve that is disposed on a first intake line that supplies outside air to an intake manifold, a second intake line that bypasses the intake route control valve, a first exhaust line in which exhaust gas that is exhausted from an exhaust manifold flows, a second exhaust line that bypasses an exhaust route control valve disposed on the first exhaust line to join the first exhaust line, a turbocharger that is operated by exhaust gas flowing in the second exhaust line to compress intake air flowing in the second intake line, and a first catalyst unit that is disposed at a downstream side of the exhaust route control valve on the first exhaust line, wherein the first catalyst unit includes a first brick that is disposed at an upstream side and a second brick that is disposed at a downstream side of the first brick with a predetermined distance therefrom, and the second exhaust line joins the first exhaust line at a portion between the first brick and the second brick.

The second intake line may be diverged from an air cleaner box, sequentially pass a compressor of the turbocharger and an intercooler to join the first intake line. The second exhaust line may be diverged from the exhaust manifold, pass a turbine of the turbocharger to join the first exhaust line.

The engine having a turbocharger may further include a second catalyst unit that is disposed at a downstream side of the first catalyst unit. The engine having a turbocharger may further include a control portion that controls the intake route control valve and the exhaust route control valve depending on a driving condition.

The first catalyst unit may includes a catalyst unit casing in which the first brick and the second brick are disposed, wherein the second exhaust line joins the catalyst unit casing. The control portion may open the exhaust route control valve such that the exhaust gas passes the first brick and the second brick of the first catalyst unit, for a predetermined time after the engine is started.

According to the present invention, an exhaust route control valve is controlled such that exhaust gas is supplied to a turbine of a turbocharger, and exhaust gas that is exhausted from the turbine is supplied to a part between a first brick and a second brick of a first catalyst unit so that the back pressure of exhaust gas is decreased. Accordingly, output is improved by the decrement of the back pressure, and fuel consumption is decreased.

Also, on a gasoline engine of a conventional natural intake method, a turbocharger is used to charge air at a speed slower than a predetermined rotation speed such that a torque is increased and fuel consumption is reduced at the lower speed area.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic diagram of an exemplary engine having a turbocharger according to the present invention.

FIG. 2 is a schematic diagram showing a partion of an exemplary engine having a turbocharger according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

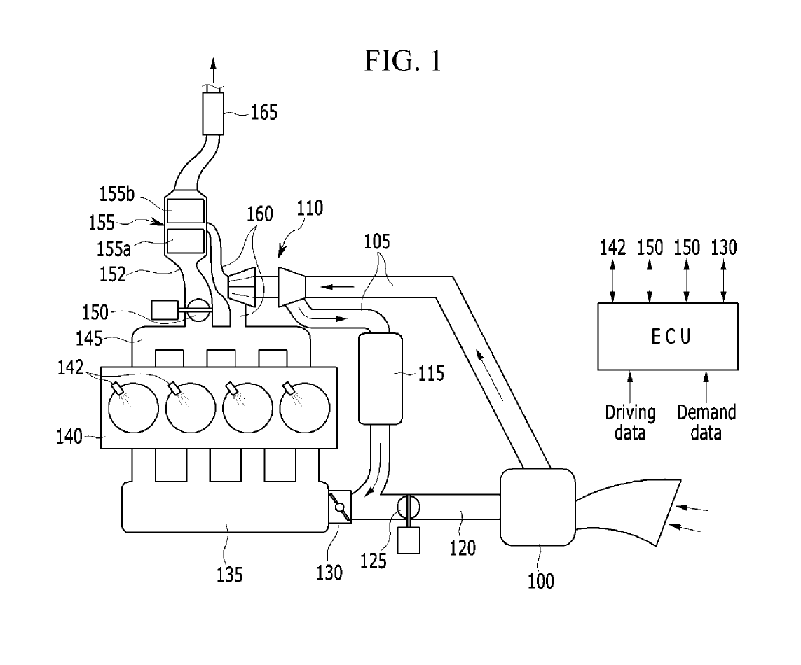

FIG. 1 is a schematic diagram of an engine having a turbocharger according to various embodiments of the present invention. Referring to FIG. 1, an engine having a turbocharger includes an air cleaner box 100, a first intake line 120, a second intake line 105, a throttle body 130, an intake manifold 135, a cylinder block 140, an injector 142, an exhaust manifold 145, a first exhaust line 152, an exhaust route control valve 150, an intake route control valve 125, an intercooler 115, a second exhaust line 160, a turbocharger 110, a first catalyst unit 155, a second catalyst unit 165, and a control portion such as an electronic control unit (ECU) or a control portion including an ECU.

The second intake line 105 bypasses the intake route control valve 125 and is diverged from the air cleaner box 100, and passes a compressor and an intercooler 115 of the turbocharger 110 to join the first intake line 120.

The throttle body 130 is disposed at a part that the first intake line 120 and the second intake line 105 are joined. Here, in some embodiments, the second intake line 105 is not diverged from the air cleaner box 100 and can be diverged from the first intake line 120.

The first exhaust line 152 is diverged from the exhaust manifold 145, and the exhaust route control valve 150, the first catalyst unit 155, and the second catalyst unit 165 are sequentially disposed on the first exhaust line 152.

The second exhaust line 160 bypasses the exhaust route control valve 150, and the second exhaust line 160 is diverged from the exhaust manifold 145 to join the first exhaust line 152. Here, in some embodiments, the second exhaust line 160 is not diverged from the exhaust manifold 145 can be diverged from the first exhaust line 152.

In various embodiments of the present invention, while the control portion (ECU) closes the intake route control valve 125, intake air is supplied to the intake manifold 135 through a compressor and an intercooler 115 of the turbocharger 110 on the second intake line 105.

Further, while the control portion (ECU) opens the intake route control valve 125, intake air is supplied to a combustion chamber of a cylinder block 140 through the first intake line 120 and the throttle body 130.

If the control portion (ECU) completely opens the exhaust route control valve 150, exhaust gas passes a first catalyst unit 155 and a second catalyst unit 165 of the first exhaust line 152 to be exhausted to the outside, and if the exhaust route control valve 150 is closed, exhaust gas operates a turbine of the turbocharger 110 through the second exhaust line 160 and passes the first catalyst unit 155 and the second catalyst unit 165 to be exhausted to the outside.

The control portion (ECU) adjusts opening rate or opening amount of the exhaust route control valve 150 to control the operation of the turbocharger 110, detects a driving condition of an engine and a driver's demand condition through an acceleration sensor and a brake sensor to calculate a demand torque, and controls the intake route control valve 125, the exhaust route control valve 150, and the injector 142 to inject fuel.

In various embodiments of the present invention, the turbocharger 110 is used to further supply air at a lower speed less than a predetermined value on a natural intake method gasoline engine to increase torque and maintains an engine performance of a natural intake method type without help of the turbocharger 110 at a high speed area higher than a predetermined value.

Further, the capacity of the turbocharger 110 is characterized in that air flow coefficient thereof is less than 2 based on air flow rate passing a compressor, and herein the air flow coefficient is defined by maximal air flow rate passing compressor (kg/h)/exhaust amount (Liter). And, the charging of the turbocharger 110 can be performed at a speed less than a predetermined engine speed that maximal torque is formed from natural intake method engine.

Accordingly, the intake route control valve 125 and the exhaust route control valve 150 are all completely opened at a speed higher than the predetermined engine speed and the engine shows a performance similar or equal to that of the natural intake method.

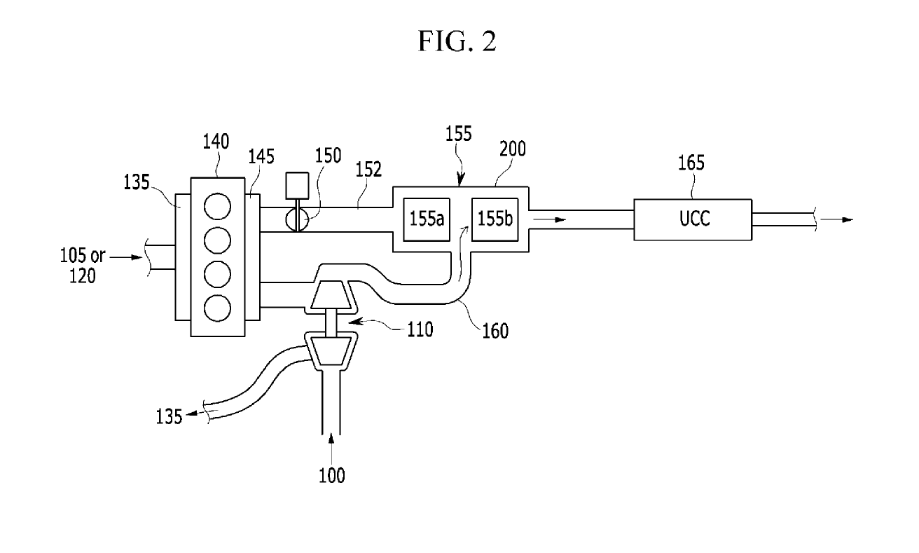

FIG. 2 is a schematic diagram showing a part of an engine having a turbocharger according to various embodiments of the present invention.

Referring to FIG. 2, the first catalyst unit 155 is disposed at a downstream side of the exhaust route control valve 150 on the first exhaust line 152 to purify exhaust gas, and the first catalyst unit 155 includes a first brick 155a that is disposed at a front or upstream side and a second brick 155b that is disposed at a rear or downstream side thereof.

Further, the second exhaust line 160 is diverged from the exhaust manifold 145, passes a turbine of the turbocharger 110, and joins the first exhaust line 152 between the a first brick 155a and the a second brick 155b of the a first catalyst unit 155. And, the second catalyst unit 165 is disposed at a downstream side of the first catalyst unit 155 and purifies exhaust gas passing the first exhaust line 152 together with the first catalyst unit 155.

Further, the first catalyst unit 155 includes one catalyst unit casing 200, the first brick 155a and the a second brick 155b are disposed in the catalyst unit casing 200 respectively at an upstream side and a downstream side with a predetermined distance, and the second exhaust line 160 joins a middle side of the catalyst unit casing 200.

In various embodiments of the present invention, the control portion (ECU) controls the exhaust route control valve 150 at a predetermined driving condition and supplies a turbine of the turbocharger 110 with exhaust gas.

And, exhaust gas that is exhausted from a turbine of the turbocharger 110 is supplied to a part between the first brick 155a and the second brick 155b of the first catalyst unit 155 such that back pressure of exhaust gas is decreased. Accordingly, overall output efficiency and fuel combustion efficiency are improved due to the deterioration of exhaust gas back pressure.

Also, because the amount of the cell of the first brick 155a of the a first catalyst unit 155 is large, the back pressure of exhaust gas is further increased, however because exhaust gas passing the turbine of the turbocharger 110 is exhausted to a downstream side of the first brick 155a, the back pressure can be effectively reduced.

Further, the control portion (ECU) opens the exhaust route control valve 150 for a predetermined time after an engine is started such that exhaust gas passes the first brick 155a and the a second brick 155b, and therefore the LOT (light off time) of the first catalyst unit 155 is decreased and exhaust gas quality is improved.

For convenience in explanation and accurate definition in the appended claims, the terms “front” or “rear”, “upstream” or “downstream”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An engine having a turbocharger, comprising:
an intake route control valve that is disposed on a first intake line that supplies outside air to an intake manifold;
a second intake line that bypasses the intake route control valve;
a first exhaust line in which exhaust gas that is exhausted from an exhaust manifold flows;
a second exhaust line that bypasses an exhaust route control valve disposed on the first exhaust line to join the first exhaust line;
a turbocharger that is operated by exhaust gas flowing in the second exhaust line to compress intake air flowing in the second intake line; and
a first catalyst unit that is disposed at a downstream side of the exhaust route control valve on the first exhaust line,
wherein the first catalyst unit includes a first brick that is disposed at an upstream side and a second brick that is disposed at a downstream side of the first brick with a predetermined distance therefrom, and
the second exhaust line joins the first exhaust line at a portion between the first brick and the second brick.

2. The engine having a turbocharger of claim 1, wherein the second intake line is diverged from an air cleaner box, sequentially passes a compressor of the turbocharger and an intercooler to join the first intake line.

3. The engine having a turbocharger of claim 1, wherein the second exhaust line is diverged from the exhaust manifold, passes a turbine of the turbocharger to join the first exhaust line.

4. The engine having a turbocharger of claim 1, further comprising:
a second catalyst unit that is disposed at a downstream side of the first catalyst unit.

5. The engine having a turbocharger of claim 1, further comprising:
a control portion that controls the intake route control valve and the exhaust route control valve depending on a driving condition.

6. The engine having a turbocharger of claim 1, wherein the first catalyst unit comprising:
a catalyst unit casing in which the first brick and the second brick are disposed, wherein the second exhaust line joins the catalyst unit casing.

7. The engine having a turbocharger of claim 5, wherein the control portion opens the exhaust route control valve such that the exhaust gas passes the first brick and the second brick of the first catalyst unit, for a predetermined time after the engine is started.
